(19) United States
(12) Patent Application Publication
(10) Pub. No.: US 2025/0360853 A1
(43) Pub. Date: Nov. 27, 2025

(54) PIVOTALLY MOUNTED ARMREST AND MOTOR VEHICLE

(71) Applicant: Dr. Ing. h.c. F. Porsche Aktiengesellschaft, Stuttgart (DE)

(72) Inventor: Michael PANDURA, Bietigheim-Bissingen (DE)

(21) Appl. No.: 19/207,391

(22) Filed: May 14, 2025

(30) Foreign Application Priority Data
May 22, 2024 (DE) 10 2024 114 218.9

(51) Int. Cl. B60N 2/75; B60N 2/90; B60R 11/00

(52) U.S. Cl. CPC B60N 2/753; B60N 2/919; B60R 2011/0007; B60R 2011/0094

(57) ABSTRACT

A pivotally mounted armrest includes a fixed bearing block, on which the armrest is pivotally supported between a lowered arm support position and a raised upright position about a pivot axis; and a spring-loaded detent device configured to assist in locking the armrest in the raised upright position. The spring-loaded detent device is combined with an acoustic decoupling device.

### CROSS-REFERENCE TO RELATED APPLICATIONS

This application claims benefit to German Patent Application No. DE 10 2024 114 218.9, filed on May 22, 2024, which is hereby incorporated by reference herein.

### FIELD

The invention relates to a pivotally mounted armrest with a fixed bearing block, and to a motor vehicle with such a pivotally mounted armrest.

### BACKGROUND

German patent specification DE 100 52 838 B4 discloses an armrest, particularly a center armrest, of a motor vehicle that can pivot between a vertical and a horizontal position and can be fixed in at least one position at high accelerations by means of a detent device, wherein the detent device includes an extendable latch bolt, wherein a detent device is provided for positioning the latch bolt, which is effective at low accelerations and secures the armrest, and wherein the latch bolt secures the armrest only at higher accelerations, wherein the detent device comprises a separate holding element that applies a holding force, particularly a spring element, wherein the detent device is configured as a ball detent and comprises a cam disc arranged on the vehicle side with a curved track, wherein the cam disc is arranged in the area of the pivot axis of the armrest. The German disclosure document DE 10 2008 030 384 A1 discloses a storage compartment that can be closed by means of a pivotable lid, wherein the lid can be latched with a detent device into an intermediate position between a basic and an open position. The German disclosure document DE 10 2010 005 812 A1 discloses an instrument panel with a storage compartment that can be closed by means of a pivotable lid, wherein the lid can be latched into different intermediate positions. The German patent specification DE 10 2018 120 087 B3 discloses an armrest located on a center console, which can pivot between different positions and cover a storage compartment.

### SUMMARY

In an embodiment, the present disclosure provides a pivotally mounted armrest including a fixed bearing block, on which an armrest is pivotally supported between a lowered arm support position and a raised upright position about a pivot axis; and a spring-loaded detent device configured to assist in locking the armrest in the raised upright position. The spring-loaded detent device is combined with an acoustic decoupling device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a perspective view of the pivotally mounted armrest according to an embodiment of the present invention;

FIG. 2 shows a cross-section of a spring-loaded detent device combined with an acoustic decoupling device according to an embodiment of the present invention;

FIG. 3 is a perspective view of a ramp body of the spring-loaded detent device combined with the acoustic decoupling device according to an embodiment of the present invention;

FIG. 4 is a perspective view of a pressure fitting of the spring-loaded detent device combined with the acoustic decoupling device according to an embodiment of the present invention; and

FIG. 5 is an exploded view of the pivotally mounted armrest from FIG. 1.

### DETAILED DESCRIPTION

An embodiment of the present invention relates to a pivotally mounted armrest with a fixed bearing block, on which the armrest is pivotally mounted between a lowered arm support position and a raised upright position about a pivot axis, and with a spring loaded detent device, which helps to lock the armrest in its raised upright position.

Embodiments of the present invention functionally improve a pivotally mounted armrest.

These improvements can be provided by a pivotally mounted armrest having a fixed bearing block, on which the armrest is pivotally supported between a lowered arm support position and a raised upright position around a pivot axis, and with a spring-loaded detent device which helps to lock the armrest in its raised upright position, characterized in that the spring-loaded detent device is combined with an acoustic decoupling device. The acoustic decoupling device advantageously prevents undesirable noise transmission between the armrest and the bearing block, as well as in the reverse direction. The pivotally mounted armrest is, in a preferred embodiment, associated with a center console in a motor vehicle. For example, the motor vehicle is a passenger car in which the pivotally mounted armrest is located between a driver's seat and a passenger seat. Depending on the design, the pivotally mounted armrest can be positioned above a storage compartment in the center console of the motor vehicle to close this compartment in the arm support position.

A preferred embodiment of the pivotally mounted armrest is characterized in that the acoustic decoupling device comprises at least one ramp body mechanically coupled to a pressure fitting of the spring-loaded detent device through the interposition of a spring-loaded detent body. The mechanical coupling of the pressure fitting to the ramp body via the detent body achieves the desired latching function of the spring-loaded detent device. Additionally, the acoustic decoupling device is realized through the design and configuration of the ramp body, the detent body, and the pressure fitting. Thus, the ramp body, the detent body, and the pressure fitting perform a dual function, namely both mechanical coupling and acoustic decoupling.

Another preferred embodiment of the pivotally mounted armrest is characterized in that the ramp body and the pressure fitting of the spring-loaded detent device are made from a plastic material. This provides the advantage that the ramp body and the pressure fitting are simple and cost-effective to manufacture in large quantities, for example by means of an injection molding process. Moreover, when the armrest is locked in its raised upright position, the ramp body and the pressure fitting made of plastic material effectively prevent undesirable acoustic coupling between the pivotally mounted armrest and the fixed bearing block.

Another preferred embodiment of the pivotally mounted armrest is characterized in that the spring-loaded detent body is designed as a detent ball and is biased against the ramp body. The size of the detent ball in combination with a ramp geometry on the ramp body can easily ensure stable latching of the pivotally mounted armrest in its upright position. The previously described function of the acoustic decoupling device prevents undesirable noise production, even at high speeds and on uneven driving surfaces.

A further preferred embodiment of the pivotally mounted armrest is characterized in that the spring-loaded detent body is made of a ceramic material. Depending on the design and cost constraints, the detent body can also be made of steel. However, the claimed ceramic material provides advantages in acoustic decoupling.

A further preferred embodiment of the pivotally mounted armrest is characterized in that the pressure fitting of the spring-loaded detent device is designed as a collar bushing with an inner flange projecting radially inward. A compression spring is supported on this inner flange and is biased against the detent body, which is guided at the end of the collar bushing opposite to the inner flange in an axial end section of the collar bushing. Thus, using simple manufacturing methods, both a stable mechanical coupling and an effective acoustic decoupling are achieved.

A further preferred embodiment of the pivotally mounted armrest is characterized in that the pressure fitting designed as a collar bushing has an outer flange projecting radially outward at its end opposite to the inner flange. This outer flange supports the pressure fitting, designed as a collar bushing, on the bearing block. This significantly simplifies the assembly of the spring-loaded detent device combined with the acoustic decoupling device.

Another preferred embodiment of the pivotally mounted armrest is characterized in that the ramp body is attached to a pivot body that supports a shaft, and to which the armrest is attached. For example, the ramp body is attached to the pivot body using at least one screw. The armrest is preferably not fixed directly to the pivot body, but rather through interposition of the lower part of the armrest. The shaft may be arranged fixedly in the pivot body. Then, the shaft may also be referred to as a pivot pin or pivot axis. The shaft is advantageously combined in the pivot body with a spring mechanism. The shaft preferably projects out of the pivot body with its two opposite shaft ends, which are also referred to as shaft stubs. With these shaft ends or shaft stubs, the pivot body with the armrest is pivotally supported on the bearing block about the pivot axis.

A further preferred embodiment of the pivotally mounted armrest is characterized in that the ramp body comprises two ramps rising upward towards one other, meeting at a highest point. The ramps preferably have different slopes. Advantageously, a ramp effective when swinging up or raising the armrest has a lower slope than a second ramp that is effective when closing or lowering the armrest from its upright position. When lowering the armrest downward from its upright position, a detent mechanism realized with the two ramps and the highest point advantageously has a significantly greater resistance than in the opposite direction, i.e. when swinging up or raising the armrest. A detent recess is advantageously provided between the steeper ramp and the highest point, which ensures that the armrest is locked in its upright position.

Another preferred embodiment of the pivotally mounted armrest is characterized in that the bearing block is attached to a center console support structure of a motor vehicle. The bearing block in combination with the pivot body is used to form a hinge for the pivotally mounted armrest. On the bearing block, a spring-loaded detent device with a previously described acoustic decoupling device is preferably combined adjacent to two ends of the pivot axis.

Embodiments of the present invention further relate to a bearing block, a pivot body, a detent device, and/or an acoustic decoupling device, and in particular embodiments, a pressure fitting, a detent body, a ramp body, for a previously described pivotally mounted armrest. The aforementioned parts can be purchased separately.

Embodiments of the present invention further relate to a motor vehicle with a pivotally mounted armrest as described above.

Further advantages, features, and details of the embodiments of the present invention arise from the following description, in which various embodiments of the present invention are described in detail with reference to the drawings.

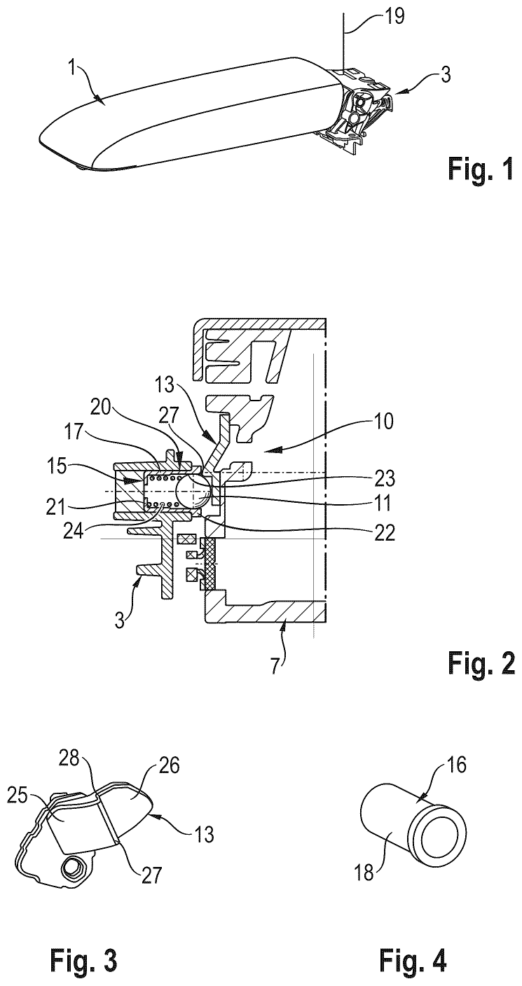

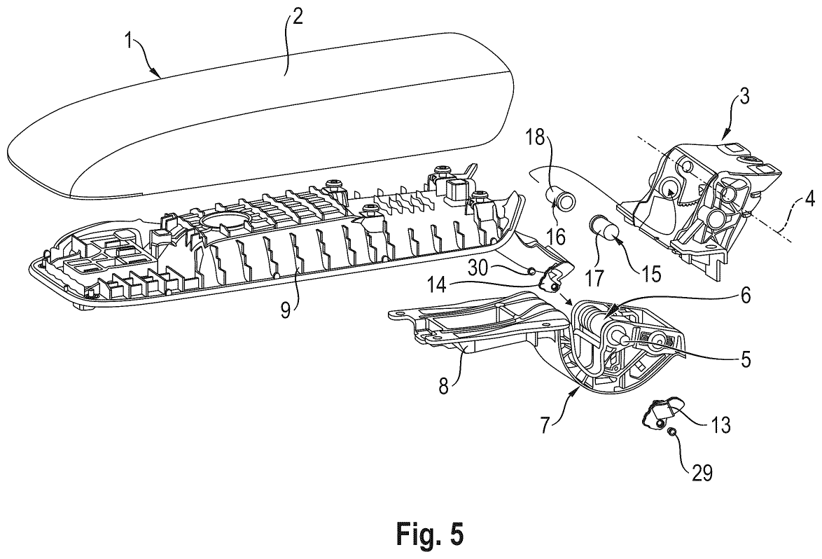

FIGS. 1 to 5 show a pivotally mounted armrest 1 in various views and with various details. The pivotally mounted armrest 1 is pivotally supported on a fixed bearing block 3 between a lowered arm support position shown in FIG. 1 and a raised upright position 19 indicated in FIG. 1 by only a vertical line about a pivot axis designated in FIG. 5 with the reference numeral 4.

In its lowered arm support position shown in FIG. 1, the armrest 1 serves as an arm support 2. The armrest 1 with the arm support 2 is associated with a center console of a motor vehicle. The center console with the armrest 1 is located in the motor vehicle, which is designed as a passenger car, between a driver's seat and a passenger seat.

The armrest 1 with the arm support 2 also advantageously serves to cover a storage compartment integrated into the center console in the motor vehicle. In its lowered arm support position shown in FIG. 1, the armrest 1 closes the storage compartment located below. In its upright position 19, the pivotally mounted armrest 1 opens the storage compartment.

In the exploded view of FIG. 5, it can be seen that the armrest 1 with the arm support 2 is attached to a lower part of the armrest 9. A fastening body 8 of a pivot body 7 is attached to the lower part of the armrest 9. The fastening body 8 is attached to the lower part of the armrest 9 using, for example, four screws. The fastening body 8 attached to the lower part of the armrest 9 is concealed by the armrest 1 with the arm support 2.

The fastening body 8 is integrally connected to the pivot body 7, which, together with the bearing block 3, serves to form a hinge for the pivot mounting of the armrest 1. The pivot body 7 is equipped with a shaft 5, which protrudes from the pivot body 7 with its opposite shaft ends or shaft stubs. Within the pivot body 7, the shaft 5 is combined with a spring mechanism 6, which is not described in detail.

Slightly below the shaft ends of shaft 5 protruding from the pivot body 7, ramp bodies 13, 14 are attached to both sides of the pivot body 7. The attachment of the ramp bodies 13, 14 to the pivot body 7 is carried out by at least one screw 29, 30, and in a preferred embodiment, in combination with a form-fitting connection.

When looking at FIGS. 2 and 5, it can be seen that the ramp bodies 13, 14 interact with detent bodies 11 and pressure fittings 15, 16 to form a detent device 10, which helps to lock the armrest 1 in its raised upright position. In FIG. 2, only the detent body 11 can be seen, which is biased against the ramp body 13 by a compression spring 24. A second detent body can interact with the ramp body 14 and the pressure fitting 16. The two pressure fittings 15, 16 are designed as collar bushings 17, 18.

FIG. 2 shows that the collar bushing 17 has the shape of a straight circular cylinder jacket. An inner flange 21 is formed on the left end of the collar bushing 17 in FIG. 2, on which the compression spring 24 rests. At the opposite end of the collar bushing 17, an outer flange 22 is formed, with which the collar bushing 17 rests against the peripheral edge of a corresponding receptacle of the bearing block 3.

As shown in FIG. 2, the detent body 11, which is designed as a detent ball, is guided in an axial end section in FIG. 2 to move left and right. The compression spring 24 biases the detent body 11 to the right against the ramp body 13 in FIG. 2.

FIG. 3 shows that the ramp body 13 comprises two ramps 25, 26 with opposite slopes. The two ramps 25, 26 meet at a highest point 27. Looking at FIG. 2, it is evident that the ramp 13 has a detent recess 28 at the highest point 27. FIG. 2 further shows how the detent body 11 engages with the ramp body 13 in front of the highest point 27 between the two ramps.

When pivoting the armrest 1 with the arm support 2 upwards, the locking mechanism is achieved by means of the two detent bodies 11 interacting with the ramp bodies 13, 14. By means of the compression spring 24 in the pressure fitting 15, the detent body 11 is pressed against the ramp body 13. The detent body 11 snaps over the highest point 27 when the armrest 1 is pivoted up, and thus holds the armrest 1 with the arm support 2 in its upright position.

The release is performed in the opposite direction by pulling on the armrest 1 with the arm support 2 with a correspondingly higher force. The detent body 11, which is configured as a detent ball, is made of a ceramic material for acoustic reasons. The ramp bodies 13, 14 and the pressure fittings 15, 16 are formed from a plastic material. The plastic material is, in a preferred embodiment, a polyoxymethylene with the abbreviation POM.

For one thing, this plastic has optimal sliding properties. In addition, this plastic allows for effective acoustic decoupling.

The detent body 11, which is configured as a detent ball, is acoustically decoupled particularly advantageously in both directions, that is, in the direction of the respective pressure fitting as well as in the direction of the ramp body. Thus, an undesirable transmission of mechanical noises at this point can be assuredly prevented.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMBERS

1 Armrest
2 Arm support
3 Bearing block
4 Pivot axis
5 Shaft
6 Spring mechanism
7 Pivot body
8 Fastening body
9 Lower part of the armrest
10 Detent device
11 Detent body
13 Ramp body
14 Ramp body
15 Pressure fitting
16 Pressure fitting
17 Collar bushing
18 Collar bushing
19 Upright position
20 Acoustic decoupling device
21 Inner flange
22 Outer flange
23 Axial end section
24 Compression spring
25 Ramp
26 Ramp
27 Highest point
28 Detent recess
29 Screw
30 Screw

1. A pivotally mounted armrest, comprising:
a fixed bearing block, on which the armrest is pivotally supported between a lowered arm support position and a raised upright position about a pivot axis; and
a spring-loaded detent device configured to assist in locking the armrest in the raised upright position,
wherein the spring-loaded detent device is combined with an acoustic decoupling device.

2. The pivotally mounted armrest according to claim 1, wherein the acoustic decoupling device comprises at least one ramp body mechanically coupled to a pressure fitting of the spring-loaded detent device through an interposition of a spring-loaded detent body.

3. The pivotally mounted armrest according to claim 2, wherein the at least one ramp body and the pressure fitting of the spring-loaded detent device are formed from a plastic material.

4. The pivotally mounted armrest according to claim 2, wherein the spring-loaded detent body is configured as a detent ball and is biased against the ramp body.

5. The pivotally mounted armrest according to claim 2, wherein the spring-loaded detent body is formed from a ceramic material.

6. The pivotally mounted armrest according to claim 2, wherein the pressure fitting of the spring-loaded detent device is designed as a collar bushing with an inner flange projecting radially inward, a compression spring is supported on the inner flange and is biased against the spring-loaded detent body, which is guided at an end of the collar bushing opposite to the inner flange in an axial end section of the collar bushing.

7. The pivotally mounted armrest according to claim 6, wherein the pressure fitting designed as the collar bushing comprises an outer flange projecting radially outward at an end of the outer flange facing away from the inner flange, with which the pressure fitting designed as the collar bushing is supported on the fixed bearing block.

8. The pivotally mounted armrest according to claim 2, wherein the at least one ramp body is fixed to a pivot body supporting a shaft and to which the armrest is attached.

9. The pivotally mounted armrest according to claim 2, wherein the at least one ramp body comprises two ramps rising towards one other, meeting at a highest point.

10. The pivotally mounted armrest according to claim 1, wherein the fixed bearing block is fixed to a center console support structure of a motor vehicle.

11. A bearing block, pivot body, detent device or acoustic decoupling device, pressure fitting, detent body, and ramp body, for the pivotally mounted armrest according to claim 1.
